(19) United States
(12) Patent Application Publication
(10) Pub. No.: US 2019/0249627 A1
(43) Pub. Date: Aug. 15, 2019

(54) HEAT EXCHANGE APPARATUS

(71) Applicant: TOYOTA JIDOSHA KABUSHIKI KAISHA, Toyota-shi (JP)

(72) Inventor: Taku TAKAGI, Toyota-shi (JP)

(73) Assignee: TOYOTA JIDOSHA KABUSHIKI KAISHA, Toyota-shi (JP)

(21) Appl. No.: 16/239,584

(22) Filed: Jan. 4, 2019

(30) Foreign Application Priority Data
Feb. 13, 2018 (JP) 2018-023360

(51) Int. Cl. F02M 26/32; F02M 26/21; F02M 26/35

(52) U.S. Cl. CPC F02M 26/32; F28F 1/40; F02M 26/35; F02M 26/21

(57) ABSTRACT

A heat exchange apparatus that can satisfactorily discharge a liquid that is a liquid condensed when a gas is cooled is achieved. A heat exchange apparatus 1 according to one embodiment of the present disclosure exchange heat between a gas flowing through a first flow path and a fluid flowing through a second flow path. The heat exchange apparatus includes offset fins disposed along a circumferential surface of the first flow path, and a discharge path extended in an extending direction of the first flow path at a lower part of the first flow path and configured to discharge a liquid condensed from the gas by being cooled through heat exchange with the fluid. The discharge path becomes lower toward one side of the first flow path in the extending direction.

### CROSS REFERENCE TO RELATED APPLICATIONS

This application is based upon and claims the benefit of priority from Japanese patent application No. 2018-23360, filed on Feb. 13, 2018 the disclosure of which is incorporated herein in its entirety by reference.

### BACKGROUND

The present disclosure relates to a heat exchange apparatus. For example, the present disclosure relates to a heat exchange apparatus that exchanges heat between a gas flowing through a first flow path and a fluid flowing through a second flow path.

For example, Japanese Unexamined Patent Application Publication No. 2010-503817 discloses a heat exchange apparatus in which an inner pipe unit is disposed inside an outer pipe unit and that exchanges heat between a gas flowing inside the inner pipe unit and a coolant flowing through a gap between the inner pipe unit and the outer pipe unit to cool the gas. In order to improve heat exchange efficiency, the heat exchange apparatus of Japanese Unexamined Patent Application Publication No. 2010-503817 has a configuration in which ribs protruding radially inward from an inner circumferential surface of the inner pipe unit extend in a longitudinal direction of the inner pipe unit.

### SUMMARY

The applicant has found the following problem. The ribs of Japanese Unexamined Patent Application Publication No. 2010-503817 have a small contact area with a gas, because the ribs have a straight shape extending in the longitudinal direction of the inner pipe unit, and thus the heat exchange efficiency is low. In order to address this problem, offset fins rolled into a cylindrical shape, instead of the ribs, may be disposed inside the inner pipe unit.

In such a case, a condensed liquid is generated inside the offset fins when the gas is cooled. For example, when the heat exchange apparatus is tilted to discharge the liquid therefrom, the liquid tends to accumulate in an offset part at a lower part of the offset fins.

The present disclosure has been made in view of such a problem. An object of the present disclosure is to achieve a heat exchange apparatus capable of satisfactorily discharging a liquid condensed when a gas is cooled.

An example aspect of the present disclosure is a heat exchange apparatus for exchanging heat between a gas flowing through a first flow path and a fluid flowing through a second flow path.

The heat exchange apparatus includes: offset fins disposed along a circumferential surface of the first flow path; and

a discharge path extended in an extending direction of the first flow path at a lower part of the first flow path and configured to discharge a liquid that is the gas condensed by being cooled through heat exchange with the fluid.

The discharge path becomes lower toward one side of the first flow path in the extending direction.

With such a configuration, it is possible to satisfactorily discharge the liquid that is the gas condensed when it has been cooled from the discharge path to the outside of the first flow path.

In the above heat exchange apparatus, the offset fins are divided with spaces therebetween in a circumferential direction of the first flow path at the lower part of the first path,

divided end parts facing each other of the offset fins are formed at respective top parts of fins protruding outward from the first flow path in such a way that the divided end parts become linearly continuous in the extending direction of the first flow path, and

a gap between the divided end parts facing each other is preferably the discharge path.

With such a configuration, it is possible to form a groove-shaped discharge path by the divided end parts facing each other and the circumferential surface of the first flow path.

In the above heat exchange apparatus, a groove that extends in the extending direction of the first flow path and overlaps an offset part at a lower part of the offset fins when viewed from above is formed at the lower part of the first flow path, and the groove is preferably the discharge path.

With such a configuration, the liquid flowing down to the lower part of the first flow path can be further flowed down to the discharge path, and then discharged from the first flow path via the discharge path.

In the above heat exchange apparatus, a width dimension of the first flow path in the circumferential direction in the groove preferably becomes wider from inside to outside of the first flow path.

With such a configuration, it is possible to effectively prevent the capacity of the discharge path from decreasing and also increase the contact area between the offset fins and the circumferential surface of the first flow path as compared with the case when a width dimension of an opening of the discharge path is formed to be the same as a width dimension of a bottom part of the discharge path.

In the above heat exchange apparatus, the groove preferably has a corrugated shape that connects the offset parts to each other at the lower part of the offset fins in the extending direction of the first flow path.

With such a configuration, it is possible to reduce a non-contact part between the offset fins and the circumferential surface of the first flow path, thereby improving the cooling effect of the gas.

The above heat exchange apparatus further includes a core member to be inserted into the first flow path.

The offset fins are preferably disposed between the circumferential surface of the first flow path and a circumferential surface of the core member.

With such a configuration, the offset fins can be pressed against the circumferential surface of the first flow path, so that heat can be exchanged reliably between the gas and the liquid.

According to the present disclosure, it is possible to achieve a heat exchange apparatus capable of satisfactorily discharging a liquid condensed when a gas is cooled.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a plan view schematically showing a cylinder head in which a heat exchange apparatus according to a first embodiment is disposed;

FIG. 2 is a front view schematically showing the cylinder head in which the heat exchange apparatus according to the first embodiment is disposed;

FIG. 3 is a perspective view schematically showing the heat exchange apparatus according to the first embodiment;

FIG. 4 is an enlarged view of a part IV in FIG. 3;

FIG. 5 is a view schematically showing a downward flow of condensed water in the offset fins according to the first embodiment;

FIG. 6 is a view schematically showing a flow of the condensed water in a lower part of the offset fins in the heat exchange apparatus not including a discharge path;

FIG. 7 is a view schematically showing a flow of the condensed water in the lower part of the offset fins in the heat exchange apparatus according to the first embodiment;

FIG. 8A is a plan view schematically showing the offset fins before being rolled into a cylindrical shape;

FIG. 8B is a front view schematically showing the offset fins before being rolled into a cylindrical shape;

FIG. 9 is a front view schematically showing a cylinder head including the heat exchange apparatus according to a second embodiment;

FIG. 10 is a side view schematically showing a cylinder head including the heat exchange apparatus according to the second embodiment;

FIG. 11 is a perspective view schematically showing the heat exchange apparatus according to the second embodiment;

FIG. 12 is an enlarged view of a part XII in FIG. 11;

FIG. 13A is a view for describing a layout of a discharge path of the heat exchange apparatus according to the second embodiment.

FIG. 13B is an enlarged view of a part A1 of FIG. 13A;

FIG. 14 is a cross-sectional view taken along the line XIV-XIV of FIG. 11 schematically showing a flow of condensed water in a lower part of offset fins in the heat exchange apparatus according to the second embodiment;

FIG. 15A is a view for describing a layout of a discharge path of the heat exchange apparatus according to a third embodiment; and

FIG. 15B is an enlarged view of a part A2 in FIG. 15A.

### DESCRIPTION OF EMBODIMENTS

Hereinafter, specific embodiments to which the present disclosure is applied will be described in detail with reference to the drawings. However, the present disclosure is not limited to the following embodiments. Further, in order to clarify the descriptions, the following descriptions and drawings are simplified as appropriate.

### First Embodiment

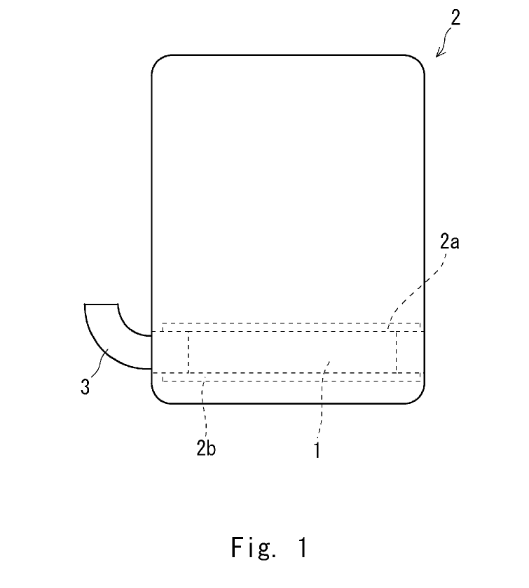

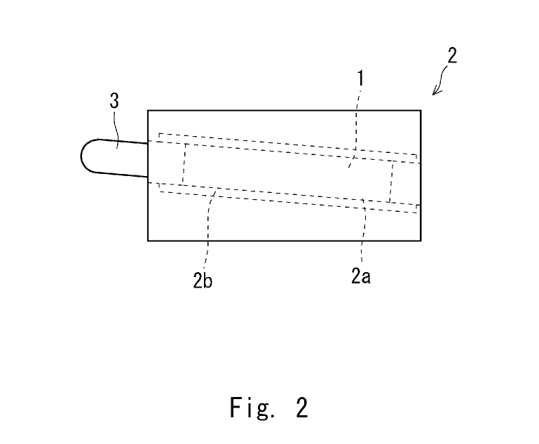

Firstly, a configuration of a heat exchange apparatus according to this embodiment will be briefly described. FIG. 1 is a plan view schematically showing a cylinder head in which a heat exchange apparatus according to this embodiment is disposed. FIG. 2 is a front view schematically showing the cylinder head in which the heat exchange apparatus according to this embodiment is disposed. In FIGS. 1 and 2, the cylinder head and the heat exchange apparatus are shown in a simplified manner.

For example, as shown in FIGS. 1 and 2, in an external EGR (Exhaust Gas Recirculation) mechanism, a heat exchange apparatus 1 according to this embodiment is disposed inside a cylinder head 2 of an engine, which is an internal combustion engine, in order to cool an exhaust gas.

The cylinder head 2 is, for example, a cast product of aluminum. An EGR path (a first flow path) 2a is formed inside the cylinder head 2. The EGR path 2a is disposed at a position close to a water jacket (a second flow path) 2b. For example, the EGR path 2a is disposed in such a way that it is surrounded by the water jacket 2b. The EGR path 2a is a straight hole having a substantially circular cross-sectional shape orthogonal to an extending direction of the EGR path 2a. However, the EGR path 2a is not limited to a substantially circular shape and may instead be an oval shape.

One side of the EGR path 2a in the extending direction communicates with an exhaust path of an exhaust gas inside the cylinder head 2 and also communicates with an exhaust manifold (not shown) connected to the cylinder head 2. The other side of the EGR path 2a in the extending direction communicates with an EGR pipe 3 connected to the cylinder head 2.

The exhaust gas flowing into the EGR path 2a is discharged to the EGR pipe 3 and is sucked into an intake path of the cylinder head 2 via an EGR valve, which is not shown. Such an EGR path 2a is inclined in such a way that it becomes lower toward the exhaust manifold side. That is, the EGR path 2a is inclined in such a way that it becomes lower toward the opposite side thereof into which the exhaust gas flows.

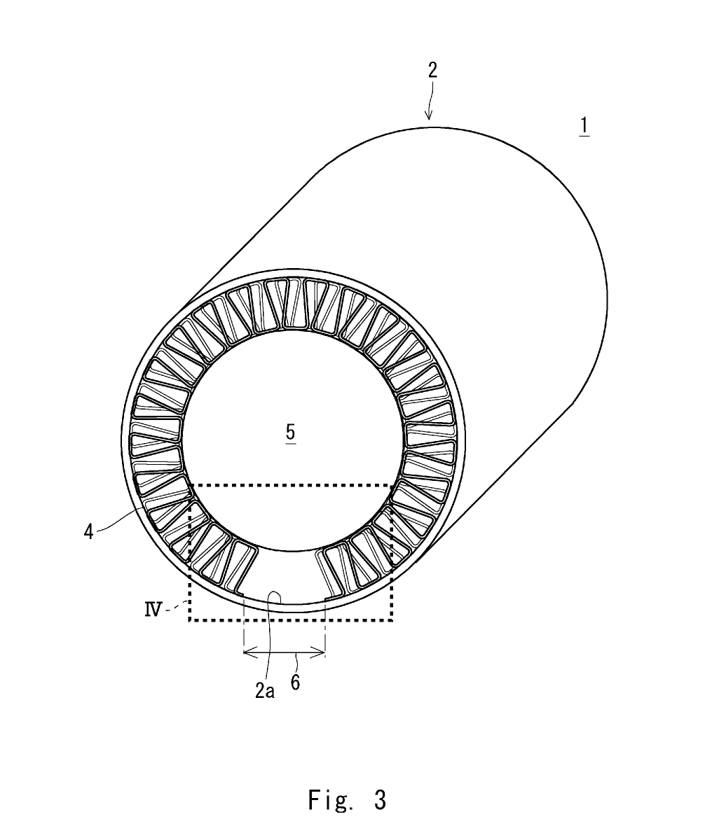

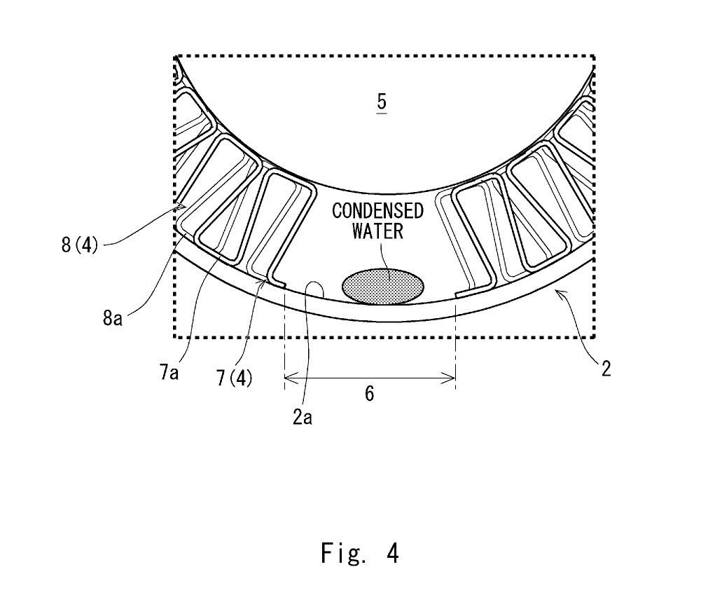

The heat exchange apparatus 1 is disposed inside the EGR path 2a in order to cool the exhaust gas by exchanging heat between the exhaust gas passing through the inside of the EGR path 2a and a coolant flowing inside the water jacket 2b of the cylinder head 2. FIG. 3 is a perspective view schematically showing the heat exchange apparatus according to this embodiment. FIG. 4 is an enlarged view of a part IV in FIG. 3. In FIGS. 3 and 4, a part of the cylinder head is extracted and shown in a tubular shape.

As shown in FIGS. 3 and 4, the heat exchange apparatus 1 includes offset fins 4, a core member 5, and a discharge path 6. The offset fins 4 are disposed inside the EGR path 2a in such a way that they extend along a circumferential surface of the EGR path 2a. A basic form of the offset fins 4 is a tubular shape. For example, the offset fins 4 are arranged in a cylindrical shape as a basic form in order to correspond to an inner shape of the EGR path 2a.

The offset fins 4 include a first band-shaped corrugated sheet 7 having a substantially regular and a continuous projected and recessed structure and a second band-shaped corrugated plate 8 having a substantially regular and continuous projected and recessed structure, which is substantially the same shape as that of the first band-shaped corrugated plate 7. In other words, the first band-shaped corrugated plate 7 includes projected fins 7a disposed substantially regularly, and the second band-shaped corrugated plate 8 also includes projected fins 8a disposed substantially regularly. Top parts of the fins 7a of the first band-shaped corrugated plate 7 and top parts of the fins 8a of the second corrugated plate 8 are disposed in such a way that they are brought into contact with the circumferential surface of the EGR path 2a.

The first band-shaped corrugated plate 7 and the second band-shaped corrugated plate 8 are alternately disposed in the extending direction of the EGR path 2a offset from each other by a preset offset amount. The offset amount here is, for example, about ¼ of a wavelength of the projected and recessed structure. In other words, the fins 7a and the fins 8a are offset from each other by a length of substantially half of the width dimension in the direction in which the projected and recessed structure of the fins 7a is continuous. Such offset fins 4 are made of, for example, a stainless steel material (SUS material).

The core member 5 is inserted inside the offset fins 4 and has a columnar shape. For example, the core member 5 has a cylindrical shape in such a way that it corresponds to the inner shape of the offset fins 4. The core member 5 presses the offset fins 4 against the circumferential surface of the EGR path 2a and promotes the flow of the exhaust gas to the offset fins 4. Such a core member 5 is made of, for example, a stainless steel material.

As will be described later in detail, the discharge path 6 extends in the extending direction of the EGR path 2a at a lower part of the EGR path 2a, and a liquid condensed from the exhaust gas by being cooled through heat exchange with the coolant (e.g., the condensed water) is discharged.

With such a configuration, the exhaust gas that has flowed into the EGR path 2a is led between the circumferential surface of the EGR path 2a and the circumferential surface of the core member 5, and heat of the exhaust gas is exchanged with that of the coolant flowing inside the water jacket 2b via the offset fins 4, so that the exhaust gas is cooled. At this time, the contact area between the offset fins 4 and the exhaust gas is large because of the projected and recessed structure of the offset fins 4, and thus the cooling effect is high.

In particular, the offset fins 4 according to this embodiment can reliably exchange the heat between the exhaust gas and the coolant, because the offset fins 4 are pressed against the circumferential surface of the EGR path 2a by the core member 5. Moreover, since the exhaust gas can be led by the core member 5 to the circumferential surface side of the EGR path 2a that has high heat exchange efficiency as compared with the center of the EGR path 2a, the cooling effect of the exhaust gas is further enhanced.

When the exhaust gas is cooled by the offset fins 4, condensed water containing sulfuric acid and the like is generated.

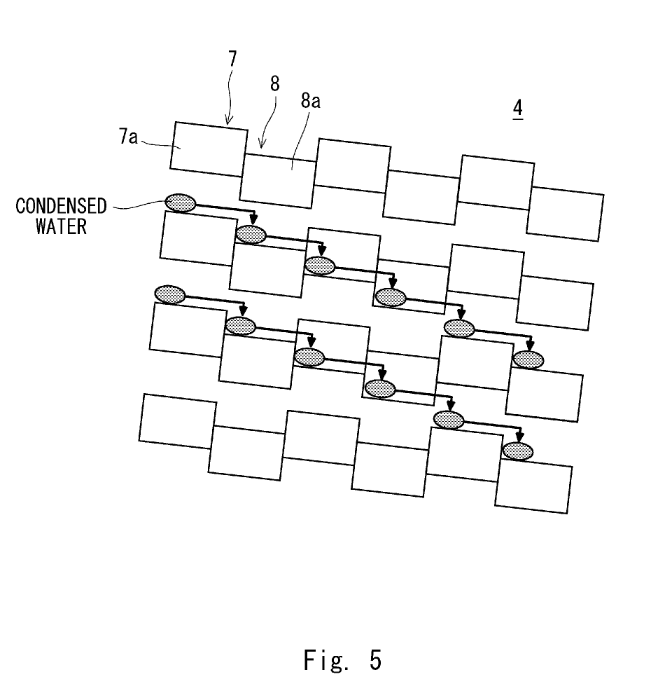

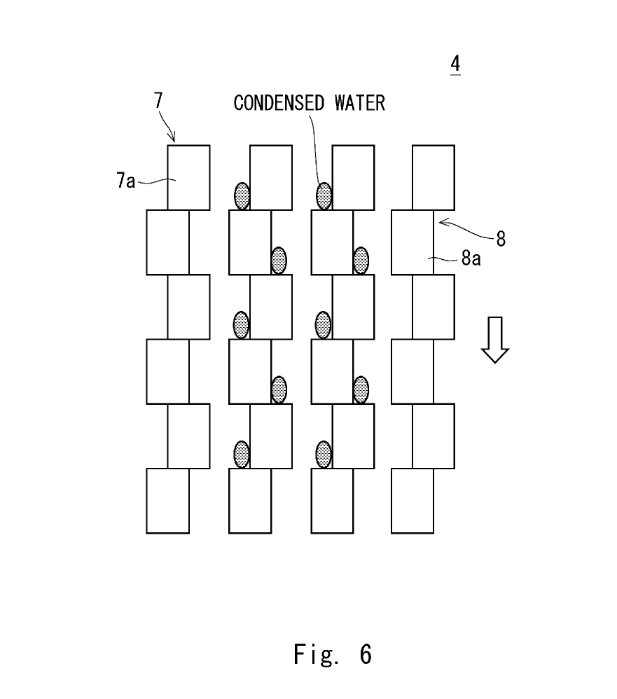

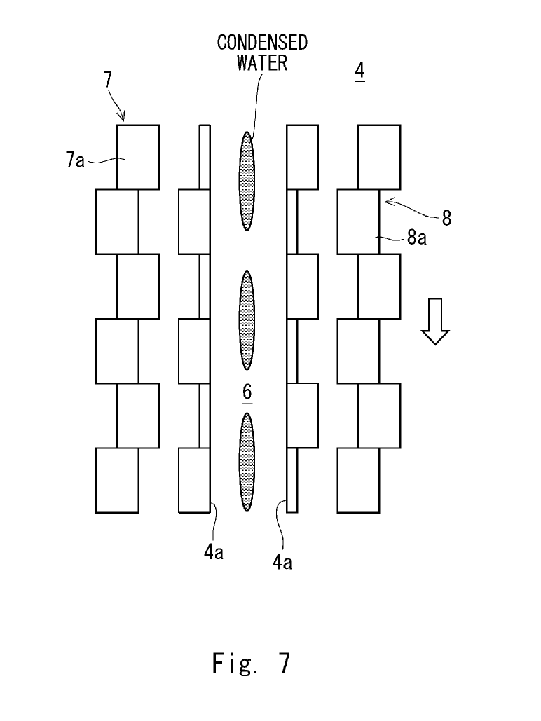

Next, a flow of the condensed water generated by the offset fins 4 according to this embodiment will be described. FIG. 5 is a view schematically showing a downward flow of the condensed water in the offset fins according to this embodiment. FIG. 6 is a view schematically showing a flow of the condensed water in the lower part of the offset fins in the heat exchange apparatus not including the discharge path. FIG. 7 is a view schematically showing a flow of the condensed water in the lower part of the offset fins in the heat exchange apparatus according to this embodiment. In FIGS. 5 to 7, the relation between the condensed water and the fins of the offset fins is shown in a simplified manner in order to clarify the flow of the condensed water. Further, in FIGS. 5 to 7, flow directions of the condensed water are indicated by arrows.

As shown in FIG. 5, the condensed water generated by the offset fins 4 flows toward a lower side (i.e., the exhaust manifold side) in the extending direction of the EGR path 2a. At this time, the condensed water flows down to fins one row lower on the lower side of the EGR path 2a in the extending direction at offset parts between fins 7a of the first band-shaped corrugated plate 7 and fins 8a of the second band-shaped corrugated plate 8. By repeating this, the condensed water is accumulated in the lower part of the EGR path 2a. The offset part here is a recess formed by offsetting the fins 7a and the fins 8a from each other.

The condensed water accumulated in the lower part of the EGR path 2a flows toward the lower side of the EGR path 2a in the extending direction. At this time, as shown in FIG. 6, when there are offset fins 4 at the lower part of the EGR path 2a, the condensed water is caught in the offset parts between the fins 7a of the first band-shaped corrugated plate 7 and the fins 8a of the second band-shaped corrugated plate 8, and the condensed water is accumulated in the offset parts.

Thus, when the offset fins 4 are present in the lower part of the EGR path 2a, there is a possibility that the condensed water cannot be discharged satisfactorily. In this case, for example, there is a possibility that the corrosion of the offset fins 4 and the like will progress due to the condensed water, if the offset fins 4 or the like are made of a stainless steel material.

Thus, as described above, the heat exchange apparatus 1 according to this embodiment includes the discharge path 6 for discharging the condensed water to the lower part of the EGR path 2a. Specifically, as shown in FIG. 7, the lower part of the offset fins 4 is divided with a space in a circumferential direction of the offset fins 4. Divided end parts 4a facing each other of the offset fins 4 are formed at the respective top parts of the fins 7a of the first band-shaped corrugated plate 7 and the top parts of the fins 8a of the second band-shaped corrugated plate 8 in such a way that they become continuous in substantially linearly in the extending direction of the EGR path 2a. The gap between the divided end parts 4a facing each other is the discharge path 6.

At this time, the divided end parts 4a facing each other constitute a linear wall part having no step in the circumferential direction of the offset fins 4. Further, a circumferential surface of the EGR path 2a having no step in the radial direction is exposed between the divided end parts 4a facing each other. As a result, the discharge path 6 is formed into a groove shape by the divided end parts 4a facing each other and the circumferential surface of the EGR path 2a.

Thus, the condensed water accumulated in the lower part of the EGR path 2a flows through the inside of the discharge path 6 without being interrupted by the offset fins 4 and is discharged to the outside of the EGR path 2a. At this time, for example, when the offset fins 4 and the like are made of a stainless steel material, it is possible to effectively prevent the corrosion of the offset fins 4 and the like from progressing due to the condensed water.

The condensed water discharged to the outside of the EGR path 2a is vaporized by heat of the exhaust gas in the exhaust manifold and exhausted together with the exhaust gas. Common exhaust manifolds are made of a highly corrosion-resistant material and thus are unlikely to corrode by the condensed water. For this reason, the exhaust manifold is convenient as a discharge unit for the condensed water.

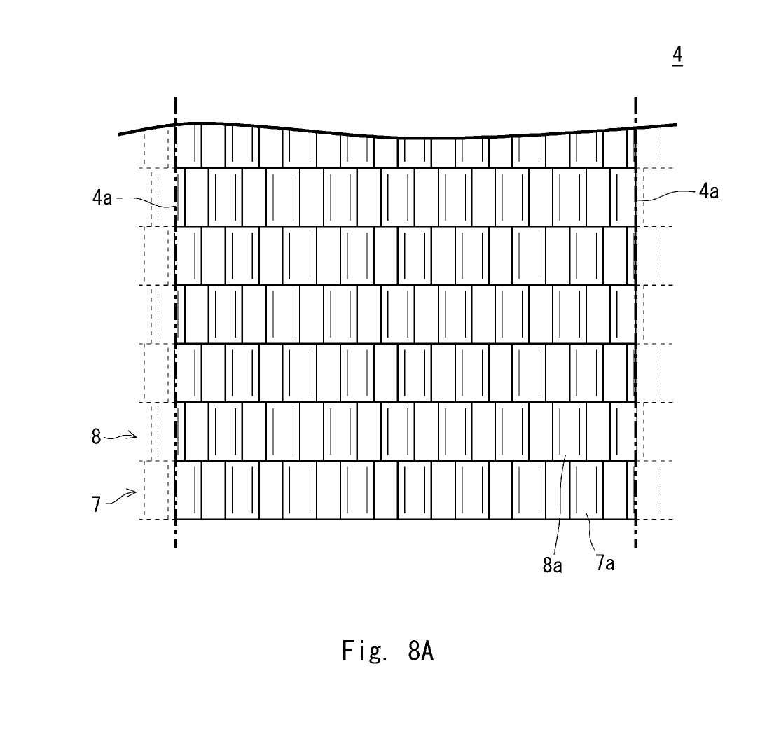

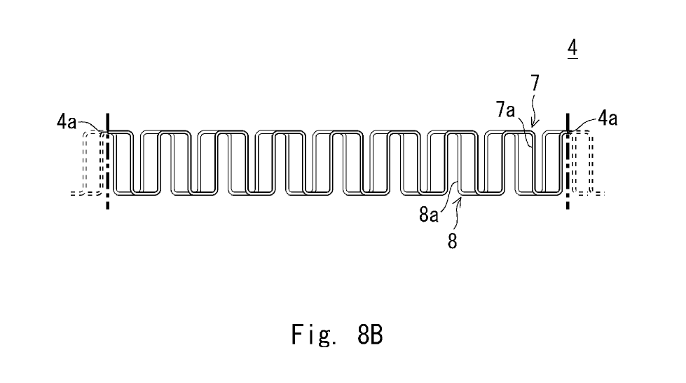

Next, a method of manufacturing the heat exchange apparatus 1 according to this embodiment will be described. FIG. 8A is a plan view schematically showing the offset fins before being rolled into a cylindrical shape. FIG. 8B is a front view schematically showing the offset fins before being rolled into a cylindrical shape. In FIGS. 8A and 8B, a cutting position is indicated by a one-dot chain line.

The offset fins 4 have the same structure as that of common offset fins. The offset fins 4 include, for example, the first band-shaped corrugated plate 7 in which rectangular wave-shaped fins 7a protrude at a preset wavelength and the second band-shaped corrugated plate 8, which has substantially the same shape as that of the first band-shaped corrugated plate 7 and in which substantially rectangular wave-shaped fins 8a protrude at a preset wavelength. That is, in the first band-shaped corrugated plate 7 and the second band-shaped corrugated plate 8, the projected and recessed structure formed by bending them at a substantially right angle are continuous.

The first band-shaped corrugated plate 7 and the second band-shaped corrugated plate 8 are bonded to each other in such a way that the projected and recessed structures of the first band-shaped corrugated plate 7 and the second band-shaped corrugated plate 8 become repeatedly continuous in a direction orthogonal to a direction in which they are continuous, in a state in which the first band-shaped corrugated plate 7 and the second band-shaped corrugated plate 8 are offset from each other by a length about half of the width dimension of the fins 7a and 8a. Such offset fins 4 are flexible so that they can be rounded.

First, both end parts of the above-described offset fins 4 are cut in such a way that when the offset fins 4 are rounded and inserted into the EGR path 2a, a predetermined space is formed between the both end parts (the divided end parts 4a) of the offset fins 4.

At this time, the cutting direction is set as a direction orthogonal to the direction in which the projected and recessed structures of the first band-shaped corrugated plate 7 and the second band-shaped corrugated plate 8 are continuous. Further, the cutting positions are set at the top parts of the fins 7a of the first band-shaped corrugated plate 7 and at the top parts of the fins 8a of the second band-shaped corrugated plate 8 so that the cutting positions become continuous in a substantially linear manner in the cutting direction.

Next, the cut-off fins 4 are rounded and inserted into a press-fitting jig (not shown), and the offset fins 4 maintained in the rounded state are inserted into the EGR path 2a. At this time, the offset fins 4 are disposed in such a way that the surfaces of the top parts of the fins 7a of the first band-shaped corrugated plate 7 and the surfaces of the top parts of the fins 8a of the second band-shaped corrugated plate 8 are brought into substantially contact with the circumferential surface of the EGR path 2a. Further, the space between the divided end parts 4a of the offset fins 4 is disposed on the lower side.

Finally, when the core member 5 is inserted inside the offset fins 4, the heat exchange apparatus 1, in which the discharge path 6 is formed between the divided end parts 4a of the offset fins 4, can be disposed inside the cylinder head 2.

In the heat exchange apparatus 1 having such a configuration, some of the offset fins 4 are omitted in the lower part of the EGR path 2a, and the groove-shaped discharge path 6 is formed by the divided end parts 4a facing each other and the circumferential surface of the EGR path 2a. This enables the condensed water accumulated in the lower part of the EGR path 2a to be discharged from the discharge path 6 to the outside of the EGR path 2a satisfactorily.

In particular, for example, when the offset fins 4 and the like are made of a stainless steel material, there is a concern that the corrosion of the offset fins 4 and the like may progress due to the condensed water. However, as described above, the heat exchange apparatus 1 according to this embodiment can discharge the condensed water to the outside of the EGR path 2a satisfactorily, thereby effectively preventing the corrosion of the offset fins 4 and the like from progressing.

Moreover, in the heat exchange apparatus 1 according to this embodiment, the contact area between the exhaust gas and the offset fins 4 is large because of the projected and recessed structure of the offset fins 4, and thus the cooling effect is high.

By the way, when the material of the offset fins 4 differs from that of the core member 5, a chemical reaction may occur between the offset fins 4 and the core member 5 due to the condensed water. For this reason, the offset fins 4 and the core member 5 are preferably made of the same material.

### Second Embodiment

In the first embodiment, the discharge path 6 is formed by omitting some of the offset fins 4 at the lower part of the EGR path 2a. However, the discharge path may be formed by forming a groove at the lower part of the EGR path 2a. In the following descriptions, repeated descriptions will be omitted, and the same members as those of the first embodiment will be described using the same reference numerals.

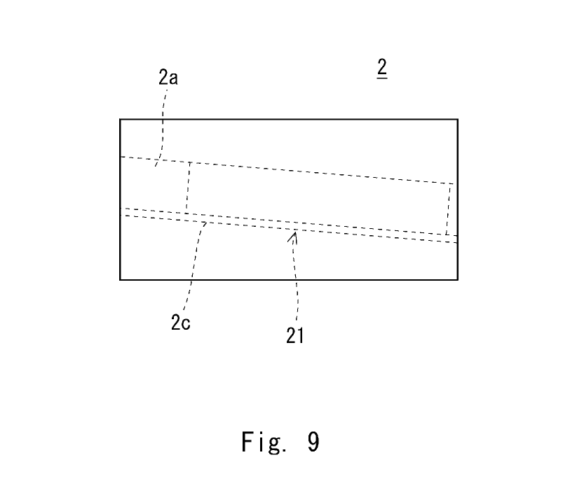

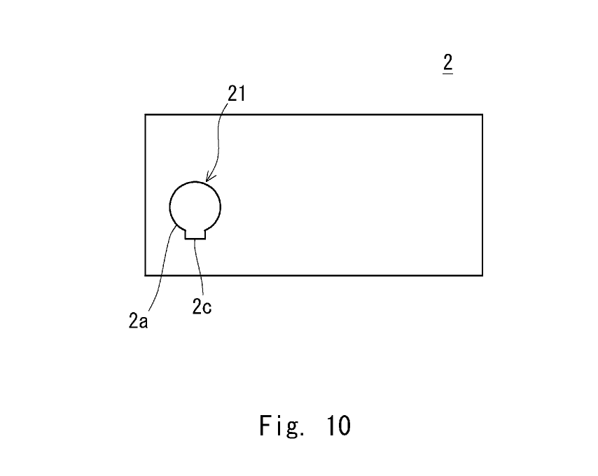

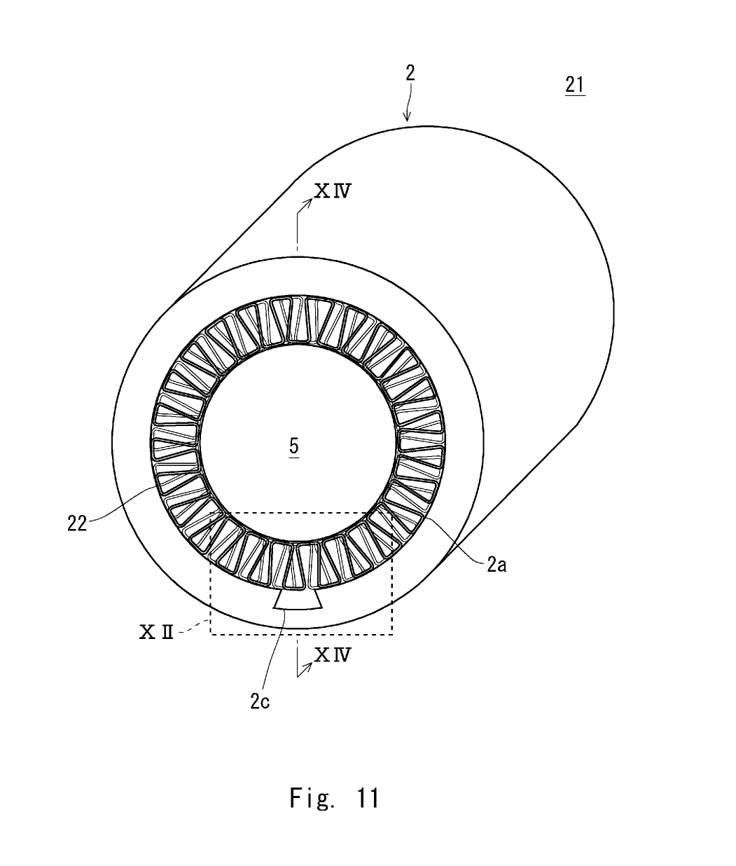

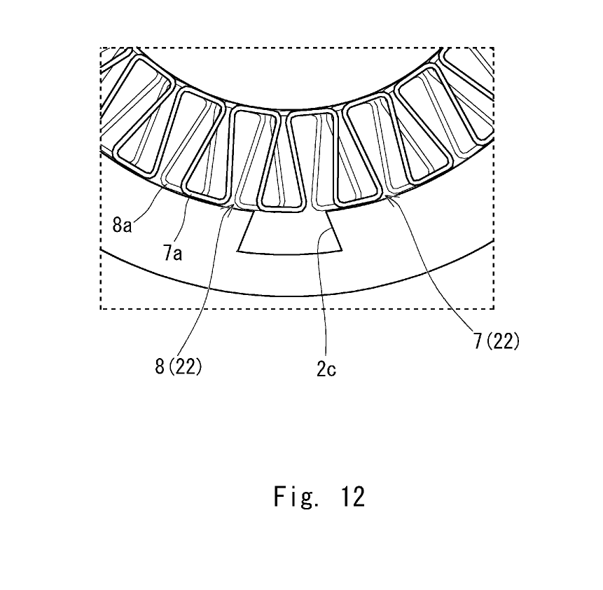

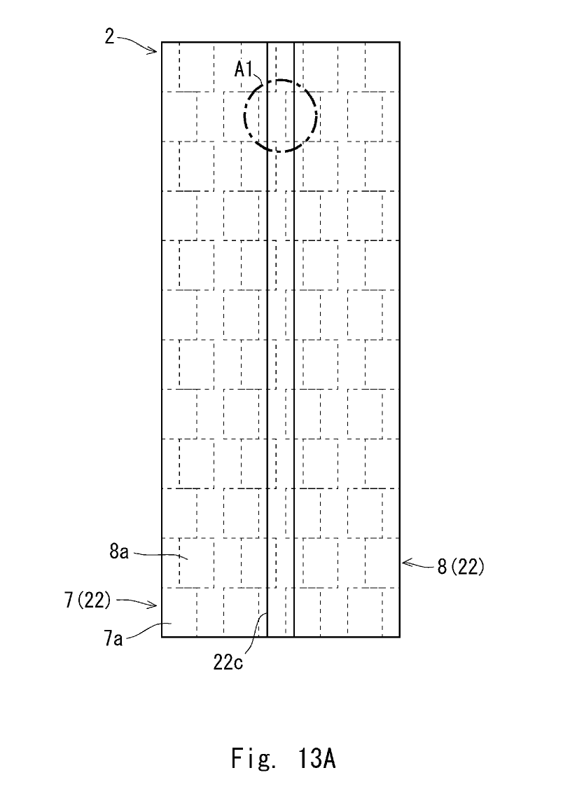

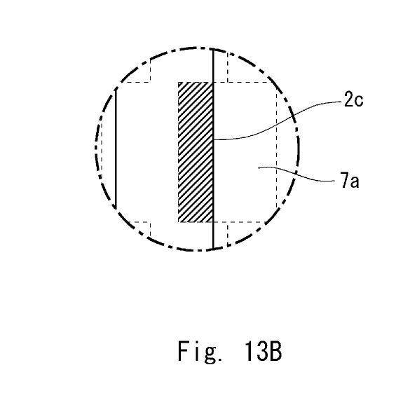

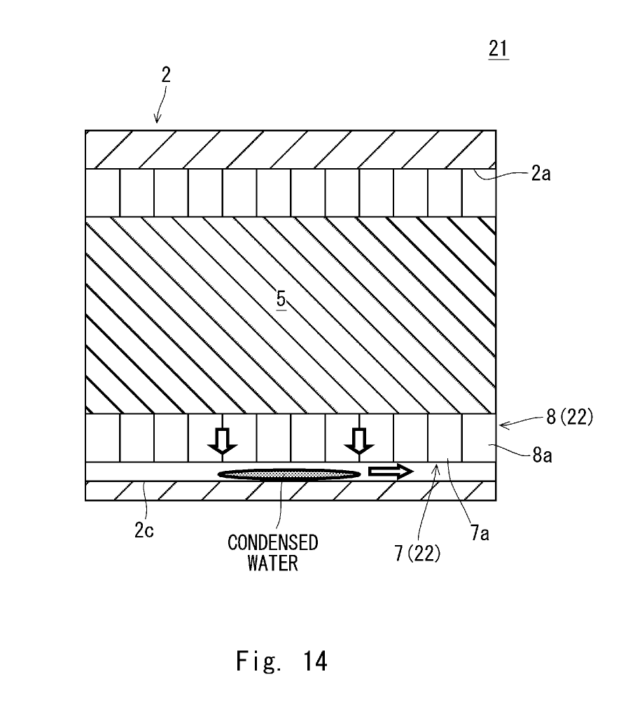

FIG. 9 is a front view schematically showing a cylinder head including a heat exchange apparatus according to this embodiment. FIG. 10 is a side view schematically showing a cylinder head including the heat exchange apparatus according to this embodiment. FIG. 11 is a perspective view schematically showing the heat exchange apparatus according to this embodiment. FIG. 12 is an enlarged view of a part XII in FIG. 11. FIG. 13A is a view for describing a layout of the discharge path of the heat exchange apparatus according to this embodiment. FIG. 13B is an enlarged view of a part A1 of FIG. 13A. FIG. 14 is a cross-sectional view taken along the line XIV-XIV of FIG. 11 schematically showing a flow of the condensed water at the lower part of the offset fins in the heat exchange apparatus according to this embodiment. In FIGS. 9 and 10, the cylinder head and the heat exchange apparatus are shown in a simplified manner, and the water jacket 2b is not shown. Further, in FIGS. 13A and 13B, a layout relation between the fins of the offset fins and the discharge path is shown in a simplified manner.

As shown in FIGS. 9 and 10, a heat exchange apparatus 21 according to this embodiment is also disposed inside the cylinder head 2 and has a substantially the same configuration as that of the heat exchange apparatus 1 according to the first embodiment except that it includes a groove 2c formed at the lower part of the EGR path 2a as a discharge path.

Here, as shown in FIGS. 11 and 12, offset fins 22 used in the heat exchange apparatus 21 according to this embodiment are formed in such a way that they are substantially continuous in the circumferential direction of the EGR path 2a. In other words, the offset fins 22 do not need to be in a form divided at the lower part thereof, like the offset fins 4 of the first embodiment. Note that in FIGS. 11 and 12, a part of the cylinder head 2 is extracted and shown in a tubular shape.

As shown in FIGS. 9 to 13A and 13B, the groove 2c extends in the extending direction of the EGR path 2a. When viewed from above, the groove 2c is formed in such a way that it overlaps at least a part of the offset part between the fins 7a of the first band-shaped corrugated plate 7 and the fins 8a of the second band-shaped corrugated plate 8. That is, when viewed from above, the discharge path 2c (hereinafter denoted by the same reference numeral as that of the groove 2c) is disposed in such a way that it overlaps at least a part of the offset part at the lower part of the offset fins 22. Such a groove 2c can be formed by a core when the cylinder head 2 is casted by aluminum die-casting.

In FIGS. 13A and 13B, the fins 7a and 8a are indicated by broken lines in order to clearly show the discharge path 2c. In FIG. 13B, a part where the discharge path 2c overlaps the offset parts of the offset fins 22 is hatched.

As shown in FIG. 14, the condensed water that has flowed down to the lower part of the EGR path 2a further flows down to the discharge path 2c, is led to the side of the exhaust manifold inside the discharge path 2c, and then is discharged from the EGR path 2a. Thus, the heat exchange apparatus 21 according to this embodiment can discharge the condensed water to the outside of the EGR path 2a satisfactorily.

In addition, since the discharge path 2c according to this embodiment is formed in such a way that it overlaps at least a part of the offset part at the lower part of the offset fins 22 when viewed from above, the condensed water accumulated in the offset part can be flowed down to the discharge path 2c satisfactorily. Thus, the condensed water is unlikely to accumulate in the offset part at the lower part of the offset fins 22. Additionally, when the offset fins 22 and the like are made of a stainless steel material, it is possible to effectively prevent the corrosion of the offset fins 22 and the like from progressing due to the condensed water.

Furthermore, the cylinder head 2 has high corrosion resistance, because an oxide film is formed on the surface of the cylinder head 2 during aluminum die-casting. For this reason, the cylinder head 2 is unlikely to corrode by the condensed water flowing down to the discharge path 2c, which is convenient for forming the discharge path 2c.

Here, as shown in FIG. 12, it is preferable that the width dimension of the EGR path 2a of the discharge path 2c in the circumferential direction become wider toward the radially outer side with respect to the center of the EGR path 2a. With such a configuration, it is possible to effectively prevent the capacity of the discharge path 2c from decreasing and also increase the contact area between the offset fins 22 and the circumferential surface of the EGR path 2a as compared with the case when a width dimension of an opening of the discharge path 2c is formed to be the same as a width dimension of a bottom part of the discharge path 2c.

### Third Embodiment

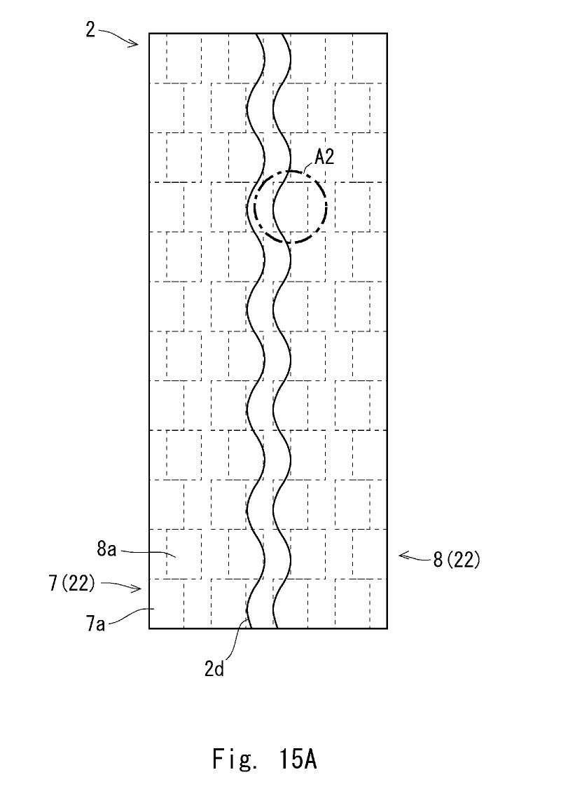

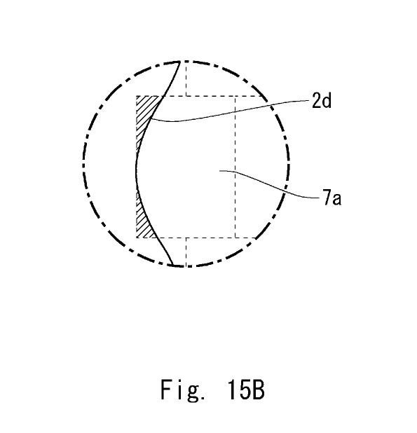

The discharge path 2c according to the second embodiment is formed as a groove extending substantially straight in the extending direction of the EGR path 2a, but the present disclosure is not limited to this. FIG. 15A is a view for describing a layout of the discharge path of the heat exchange apparatus according to this embodiment. FIG. 15B is an enlarged view of a part A2 of FIG. 15A. The heat exchange apparatus according to this embodiment has substantially the same configuration as that of the second embodiment. Thus, repeated descriptions will be omitted, and the same members as those of the first embodiment will be described using the same reference numerals.

Like the discharge path 2c according to the second embodiment, a discharge path 2d according to this embodiment is a groove formed at the lower part of the EGR path 2a. However, as shown in FIGS. 15A and 15B, the discharge path 2d has a wave shape connecting offset parts to each other at a lower part of the offset fins 22 in an extending direction of the EGR path 2a. This makes it possible to reduce a non-contact part of the offset fins 22 on a circumferential surface of the EGR path 2a as compared with the discharge path 2c according to the second embodiment, and thus the cooling effect of the exhaust gas can be enhanced as compared with the heat exchange apparatus 21 according to the second embodiment. In FIGS. 15A and 15B, fins 7a and 8a are indicated by broken lines in order to clearly show the discharge path 2d. In FIG. 15B, a part where the discharge path 2d overlaps the offset parts of the offset fins 22 is hatched.

### Fourth Embodiment

In the second and third embodiments, the discharge path is formed in the EGR path 2a, but the present disclosure is not limited to this. For example, when a heat exchange apparatus includes a tubular body into which the offset fins 22 are to be inserted, a groove may be formed at a lower part of the tubular body as the discharge path.

In this case, when the tubular body into which the offset fins 22 are to be inserted is inserted inside the EGR path 2a, the heat exchange apparatus can be easily disposed inside the cylinder head 2. Such a tubular body can be made of, for example, a stainless steel material.

The present disclosure is not limited to the above-described embodiments, and can be appropriately changed without departing from the spirit of the present disclosure.

Although the heat exchange apparatus according to the above embodiments is disposed inside the cylinder head in order to cool the exhaust gas in the external EGR mechanism, the heat exchange apparatus may be disposed at a place requiring heat exchange between a gas flowing through the first flow path and a fluid flowing through the second flow path.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A heat exchange apparatus for exchanging heat between a gas flowing through a first flow path and a fluid flowing through a second flow path, the heat exchange apparatus comprising:
offset fins disposed along a circumferential surface of the first flow path; and
a discharge path extended in an extending direction of the first flow path at a lower part of the first flow path and configured to discharge a liquid condensed from the gas by being cooled by heat exchange with the fluid, wherein
the discharge path becomes lower toward one side of the first flow path in the extending direction.

2. The heat exchange apparatus according to claim 1, wherein
the offset fins are divided with spaces therebetween in a circumferential direction of the first flow path at the lower part of the first path,
divided end parts facing each other of the offset fins are formed at respective top parts of fins protruding outward from the first flow path in such a way that the divided end parts become linearly continuous in the extending direction of the first flow path, and
a gap between the divided end parts facing each other is the discharge path.

3. The heat exchange apparatus according to claim 1, wherein a groove that extends in the extending direction of the first flow path and overlaps an offset part at a lower part of the offset fins when viewed from above is formed at the lower part of the first flow path, and the groove is the discharge path.

4. The heat exchange apparatus according to claim 3, wherein a width dimension of the first flow path in the circumferential direction in the groove becomes wider from inside to outside of the first flow path.

5. The heat exchange apparatus according to claim 3, wherein the groove includes a corrugated shape that connects the offset parts to each other at the lower part of the offset fins in the extending direction of the first flow path.

6. The heat exchange apparatus according to claim 1, further comprising a core member to be inserted into the first flow path, wherein the offset fins are disposed between the circumferential surface of the first flow path and a circumferential surface of the core member.
